(19) United States
(12) Patent Application Publication
(10) Pub. No.: US 2016/0045925 A1
(43) Pub. Date: Feb. 18, 2016

(54) INTELLIGENT SPRAY DEVICE

(71) Applicant: Airbus Operations GmbH, Hamburg (DE)

(72) Inventor: Holger Frauen, Hamburg (DE)

(21) Appl. No.: 14/819,530

(22) Filed: Aug. 6, 2015

(30) Foreign Application Priority Data
Aug. 14, 2014 (DE) 102014012140.2

(51) Int. Cl. B05B 15/04; B05B 12/08; B05B 12/12

(52) U.S. Cl. CPC B05B 15/04; B05B 12/124; B05B 12/085; B05B 12/082

(57) ABSTRACT

The application of a spraying agent by a spray device, the use of a spray device of this kind for spraying a component of an aircraft, and a method for displaying a region on a component to be sprayed. An embodiment of the spray device includes a spray unit and a light projection unit. The light projection unit is configured to project light onto a component to be sprayed as a function of at least one parameter of a spraying procedure that may be performed via the spray unit, in such a way that a resulting projection of light onto the component to be sprayed displays a region of the component to be sprayed which is sprayed during performance of the spraying procedure, using the at least one parameter.

### CROSS-REFERENCES TO RELATED APPLICATIONS

This application claims the benefit of the German patent application No. 102014012140.2 filed on Aug. 14, 2014, the entire disclosures of which are incorporated herein by way of reference.

### BACKGROUND OF THE INVENTION

The present disclosure relates in general to the application of a spraying agent. In particular, the present disclosure relates to a spray device, the use of a spray device of this kind for spraying a component of an aircraft, and a method for displaying a region on a component to be sprayed.

Nowadays, spraying agents such as paints, varnishes or protective coatings are applied to components to be sprayed in a more or less highly automated manner. For this purpose, so-called spray guns are often used, the name of these deriving from the fact that their shape is reminiscent of a gun. There are an enormous variety of areas of use, in which various types of components are to be provided with spraying agents. Possible examples that may be mentioned here are automotive construction and aircraft construction. In automotive construction, different paints are applied, for example, to different constituent parts (components) of a vehicle. As regards aircraft construction, there are also different areas of use. Purely by way of example, there may be mentioned, for example, painting aircraft constituent parts or connection elements between aircraft constituent parts (e.g., flap tracks, floor cross members). In aircraft construction, some components may be painted in a (partly) automated manner. In the case of other components, such as components in regions that are difficult to access, the paint coat is applied manually.

In the known methods for spraying components with paints, varnishes or the like, inaccuracies may naturally arise during the spraying procedure, such that the spraying agent is sometimes not applied to some components in the desired manner. For example, it may occur that a paint is also applied to locations that are not supposed to be painted. In these cases, there is an unnecessary waste of paint and an unnecessary increase in the weight of the component provided with too much paint.

It is desirable to perform a spraying procedure with as much exactness as possible.

### SUMMARY OF THE INVENTION

A first aspect relates to a spray device. The spray device includes a spray unit and a light projection unit. The light projection unit is configured to project light onto a component to be sprayed as a function of at least one parameter of a spraying procedure that is performable/executable by means of the spray unit, in such a way that a resulting projection of light onto the component to be sprayed displays a region of the component to be sprayed which is sprayed during performance/execution of the spraying procedure, using the at least one parameter.

The light projection unit can project the light onto the component. Here, the light projection unit takes account of at least one parameter of the spraying procedure to be performed by means of the spray unit. The resulting projection of light onto the component can at least almost correspond to a region that would be/is sprayed when the spraying procedure is performed if the spraying procedure were/is actually performed on the basis of the at least one parameter. Depending on whether spraying of the region is being considered in a planning phase or the region is actually sprayed, this region may also be called the “region to be sprayed” or the “sprayed region.” The spraying procedure itself may but need not be performed. With the aid of projection of the light (which may also be called by the short form “light projection”) it is possible to gain knowledge about the region that is expected to be sprayed during a spraying procedure. For example, in a planning phase of the spraying procedure, such as before the actual spraying procedure, the light projection may illuminate the region that is expected to be sprayed during a spraying procedure. If, after taking account of the light projection, the spraying procedure is to be performed, this may be done with precision. By contrast, if, after taking account of the light projection, the spraying procedure is not (initially) to be performed, the spraying procedure may also (initially) be dispensed with. Instead, for example a new light projection, based on another at least one parameter, may be performed. In addition or as an alternative to the light projection in the planning phase, light projection onto the component may be generated during a spraying procedure, for example during an application phase of the spraying agent. This light projection may be displayed on the component continuously throughout the entire spraying procedure, or repeatedly at even or uneven time intervals. With the aid of the continuous or repeated light projection onto the component, it is possible to check during the spraying procedure whether the region that is to be sprayed is actually being sprayed. To summarize, the projection of light onto the component may take place before the start of the spraying procedure and/or during the spraying procedure, for example repeatedly at time intervals and/or continuously.

To this extent, the projection of light (the generation of light projection) onto the component may be used for a type of planning phase or simulation phase. With the aid of this planning or simulation phase, a user may be enabled to know whether the desired region would be sprayed during a spraying procedure or whether adjustments are required. The planning or simulation phase may be evaluated by user intervention. In this case, the user may themselves decide whether the region of the component that is expected to be sprayed corresponds to the requirements or not, that is to say whether the spraying procedure is to be performed or whether adjustments such as a change in the spacing of the spray device from the component are to be made first. Once the adjustments have been made, a new light projection may be performed to check whether the spraying procedure can be performed, based on the simulated adjustments. This enables the start of the spraying procedure to be performed with as much exactness as possible.

On the basis of the plannability of the spraying procedure, which simultaneously makes it possible to check the expected result, unnecessary consumption of spraying agent may be at least reduced. By planning the spraying procedure already at the start, that is to say before the actual spraying procedure, a more precise spraying procedure is achieved. Because, on the basis of the plannability of the spraying procedure, the spraying agent may be applied in a more targeted manner, the risk of an unnecessary increase in weight of the sprayed component may be at least lessened.

The projection of light (the generation of light projection) onto the component may be used for a type of monitoring phase. With the aid of this monitoring phase, a user may be enabled to know during a spraying procedure whether the desired region will be sprayed during a spraying procedure or whether adjustments are required. The user can decide whether the sprayed region of the component corresponds to the requirements or not, that is to say whether the spraying procedure is performed correctly or whether adjustments such as a change in the spacing of the spray device from the component are to be made. Once the adjustments have been made, a new light projection may be performed to check whether the spraying procedure can be continued, based on the simulated adjustments. This enables the spraying procedure to be performed with as much exactness as possible.

Possible spraying agent may include any conceivable agent or material which may be applied to a component, for example to the surface of the component. The spraying agent may also be called a spraying material. The spraying material may include any kind of coating material. The spraying agent is not restricted to a certain form. It may for example be liquid, gaseous or powdered. Any desired mixtures of liquid, gaseous and powdered components may also be considered. As examples—and without being restricted thereto—there may be mentioned varnishes, paints or other protective coatings. The spraying agent may serve to form a coating on a surface of a component or a constituent part. Spraying may also include spray coating.

The light projection unit may be configured to adjust the light projection as a function of the at least one parameter. The parameter, which may also be referred to as transfer value, may be regarded as a variable by way of which the spray device, for example a computer program running on the spray device, may be “set” to particular values. To this extent, any parameter of the at least one parameter may be given a different value (parameter value). For example, a change in the at least one parameter, such as a change of the parameter to a different value (that is to say a change in the parameter value) may bring about an adjustment in the light projection. However, it is also conceivable that no change takes place in the light projection despite a change in the at least one parameter, such as a change of the parameter to a different value (that is to say a change in the parameter value). In this case, the expression “change in the at least one parameter” may be understood to mean that a minimum of one parameter of the at least one parameter changes. In the case of a plurality of parameters, it is possible for example for one or more than one, for example also all, of this plurality of parameters to be changed.

It is possible to determine from the light projection unit whether or not the light projection changes as a function of a change in the at least one parameter. On the basis of what is determined, a corresponding projection of the light by the light projection unit may be performed. For example, in the event of a change in the at least one parameter, the light projection may change in a manner corresponding to the way in which the sprayed region would change in the event of performing the spraying procedure using the changed at least one parameter. As a result, by changing the at least one parameter the light projection may be changed in the manner in which the sprayed region would change in a subsequent or current spraying procedure. It may already be sufficient if a minimum of one of the at least one parameters is changed in order to bring about an adjustment in the light projection.

The at least one parameter may include one or more of the following items of information: information relating to a spraying agent that may be used in the spraying procedure; information relating to a possible spacing between the spray device and the component to be sprayed during the spraying procedure; information relating to a spraying pressure that may be used in the spraying procedure; information relating to a jet geometry of a usable spraying agent that may be used in the spraying procedure; information relating to a position of the spray device relative to the component to be sprayed; and/or information relating to one or more environmental conditions around the spray device (such as a pressure around the spray device (negative pressure, positive pressure, etc.) and/or a humidity level around the spray device and/or a temperature around the spray device, etc.). Each of these items of information may be represented by one of the at least one parameters. For example, a first parameter may represent information relating to a spraying agent that may be used in the spraying procedure, a second parameter information relating to a possible spacing between the spray device and the component to be sprayed during the spraying procedure, a third parameter information relating to a spraying pressure that may be used in the spraying procedure, and a fourth parameter information relating to a jet geometry of a usable spraying agent that may be used in the spraying procedure. If for example the possible spacing changes, that is to say if the second parameter (the value of the second parameter) changes, then in accordance with the change the light projection unit may perform an adjustment to the light projection in order in this way to display the corresponding change in the sprayed region by a spraying procedure that is performed on the basis of the changed second parameter. For example, possible spacings may move in a range of from 5 cm to 60 cm. If for example the usable spraying pressure changes, that is to say if the third parameter (the value of the third parameter) changes, then in accordance with the change the light projection unit may perform an adjustment to the light projection in order in this way to display the corresponding change in the sprayed region by a spraying procedure that is performed on the basis of the changed third parameter.

The spray device may further include a memory unit. In the memory unit there may be stored information relating to an influence of the at least one parameter on the light projection. When the light is projected as a function of the at least one parameter, the influence of the at least one parameter on the light projection may be taken into account. If the at least one parameter changes, the light projection unit may, on the basis of the stored information relating to the influence of the at least one parameter on the light projection, adjust the light projection in accordance with the information. The information relating to the at least one influence may for example be provided as a formula, an algorithm or a type of model. Using information relating to the at least one influence, it is possible to calculate how the light projection changes in the event of a change to a parameter. If for example the at least one parameter changes, the influence of the changed at least one parameter may be retrieved from the memory unit and taken into account by the light projection unit during light projection. The information relating to the influence of the at least one parameter on the light projection may be stored in one or more tables, such as lookup tables, and retrieved from this/these.

The information relating to the influence of the at least one parameter on the light projection may be obtained in various ways and stored in the memory unit. For example, the information relating to the influence of the at least one parameter on the light projection may be obtained and updatable on the basis of performed spraying procedures. The influence of the at least one parameter on the light projection may be “learned” for example on an ongoing basis. For this purpose, a spraying procedure may for example be performed using various parameters and the light projection may be set in each case to the sprayed region. As a result, there is stored in the memory unit which parameter results in which change in the sprayed region and in which change in the light projection. It is possible to perform a plurality of tests with different parameters and to store the information gained from the plurality of tests in the memory unit.

The spray device may further include a user interface by way of which the at least one parameter may be input. The user interface may be connected to the memory unit. It is conceivable for the at least one parameter to be selectable or settable. The user interface may for example have an input unit. By way of the input unit, the at least one parameter may be input. The input unit may include for example a touch screen. As an alternative or in addition to input by way of the input unit, the user interface may be connectable to an external input device. The connection may be wireless and/or wired. An external input device of this kind may be for example a keyboard, a smartphone, a computer, a tablet PC or the like. The at least one parameter may be input with the aid of the external input device. By way of the user interface, the at least one parameter that is input may reach the spray device and be further used there. It is conceivable for example for at least some of a plurality of parameters not to be stored in the spray device itself but in an external memory unit such as an external database. If necessary, by way of the user interface the spray device may retrieve one or more parameters from the external database and use it/them to generate the light projection.

The user interface may further have an output unit. Information may be output to the user, for example being displayed, by way of the output unit. This information may be for example warning messages or information relating to the at least one parameter. For example, a spacing that is input to the spray device by way of the input unit may be displayed at the output unit.

The spray device may include a spacing measurement unit. The spacing measurement unit may be configured to determine the spacing between the spray device and the region of the component that is to be sprayed. To determine the spacing, the spacing measurement unit may take into account for example the projected and at least partially reflected light. For this purpose, the spacing measurement unit may take into account for example the propagation time of the light from transmission to partial reception. The spacing measurement unit may be part of the light projection unit.

The spray device may include a position determining unit. The position determining unit may be configured to determine the position of the spray device relative to the component to be sprayed. The position determining unit may have for example one or more position sensors. For example, with the aid of the position determining unit the deviation of the spray device from a starting position may be determined. The starting position may be a position in which a jet of spray that extends horizontally meets a component that extends vertically. The position determining unit may for example determine the number of degrees by which the spray device has been moved, for example being tilted or rotated, relative to the starting position.

The spray device may include a blocking control unit. The blocking control unit may be configured to block the spraying procedure if the spacing between the spray device and the region of the component to be sprayed lies outside a range of usable spacings and/or if the position of the spray device relative to the component to be sprayed lies outside a range of usable positions. The blocking control unit may for example block the spraying procedure if the spacing is too small, that is to say if the spacing falls below the range of usable spacings. The blocking control unit may for example block the spraying procedure if the spacing is too great, that is to say if the spacing exceeds the range of usable spacings. The spacing may be determined for example using the spacing measurement unit. The blocking control unit may for example block the spraying procedure if the angular deviation from the starting position of the spray device is too great, that is to say if the angle of the spray device in relation to the starting position exceeds the range of usable angular ranges. The position of the spray device may for example be determined using the position determining unit. With the aid of the blocking control unit, the number of spray attempts may be reduced. For example, spray attempts at spacings and/or in positions in which a useful spraying procedure is not realistic may be blocked.

In addition or as an alternative to blocking a spraying procedure, it is possible to output warning messages at the output unit of the user interface. For example, a warning message may be output if the spacing between the spray device and the region of the component to be sprayed lies outside a range of usable spacings or is close to such a range. In addition or as an alternative, a warning message may be output if the position of the spray device relative to the component to be sprayed lies outside a range of usable positions or is close to such a range.

The spray device may include an actuating element. It is possible for the actuating element to be movable from a starting position into a first and a second position. The actuating element may have a grip or the like. The spray device may include an actuation control unit. The actuation control unit may be configured, in the first position of the actuating element, to instruct the light projection unit to project the light onto the component to be sprayed as a function of the at least one parameter. The actuation control unit may, in the second position of the actuating element, instruct the spray unit to perform the spraying procedure using the at least one parameter. It is conceivable for the actuating element to be transferable by way of the first position into the second position. In this case, first the actuating element may be moved into the first position in order in this way to display a region that is expected to be sprayed with the aid of the light projection. If this display corresponds to the desired result, the actuating element may be moved into the second position in order to start the spraying procedure using the selected at least one parameter—that is to say the at least one parameter that was used before during light projection. If this display does not correspond to the desired result, the at least one parameter may be adjusted. After adjustment of the at least one parameter, the actuating element may be moved into the first position in order to display, with the aid of light projection, a region that is expected to be sprayed. If this display corresponds to the desired result, the actuating element may be moved into the second position in order to start the spraying procedure using the selected at least one parameter, etc. It is further conceivable, when the actuating element is in the second position, for a light projection onto the component to be generated during the spraying operation. The command to generate a light projection in the second position of the actuating element too may be input for example by way of the user interface. With the aid of the light projection during the spraying procedure, it is possible as described above to check the spraying procedure “on the fly”, so to speak.

The spray device may include a jet geometry control unit. The jet geometry control unit may be configured to set a geometry of a jet that is emitted by the spray unit, of a used spraying agent. Purely by way of example, circular or elliptical geometries may be mentioned here, without being restricted thereto. With the aid of the jet geometry control unit, the geometry of the jet may be adjusted. For example, the geometry of the cross section of the jet may be adjusted. The jet geometry control unit may for this purpose include a motor suitable for jet adaptation.

The light projection unit may include a laser source. The laser source may be configured to generate laser light, as the light to be projected. Thus, all the details that are described in relation to the spray device according the first aspect may be given specifically with laser light in the place of light in general.

Laser light of various wavelengths may be used. For example, when selecting the wavelength it is possible to take into account information on the initial color of the component to be sprayed, information on the light conditions, information on the color of the spraying agent and/or ergonomic aspects. An ergonomic aspect may for example relate to the visibility of the laser light. For example, it is conceivable for the wavelength of the laser light to be adjusted on the basis of information on the spacing from the spray device to the component to be sprayed and/or on the basis of information relating to the position of the spray device in relation to the component to be sprayed. For example, a laser light of a first color (e.g. a green laser light) may be used if the spacing and/or the position are in a good to ideal range. As the spacing and/or the position approach a critical range, the color of the laser light may change to a second color (e.g. yellow laser light). If the spacing and/or the position depart from a permissible range, the color of the laser light may be changed to a third color (e.g. red laser light).

A second aspect relates to the use of a spray device as described herein for spraying a component of an aircraft.

A third aspect relates to a method for displaying a region of a component to be sprayed. The spraying method includes the following steps: providing the component that is to be sprayed; providing light; and projecting light as a function of at least one parameter of a spraying procedure that is to be performed onto a component to be sprayed, in such a way that a resulting projection of the light onto the component to be sprayed displays a region of the component to be sprayed which is sprayed during performance of the spraying procedure, using the at least one parameter.

A fourth aspect relates to a computer program having programming code elements, which, when it is loaded to a computer or a processor (for example a microprocessor, microcontroller or digital signal processor (DSP)) or is running on a computer or processor (for example a microprocessor, microcontroller or DSP), causes the computer or processor (for example microprocessor, microcontroller or DSP) to perform one or more steps or all the steps of the method described above. Moreover, a program storage medium or computer program product having the said computer program is provided. Further, it is possible for example for the computer program according to the fourth aspect to be stored in the spray device according to the first aspect and for the spray device to cause one or more or all of the above-described aspects and/or steps of the method according to the third aspect to be performed.

Even where some of the aspects described above have been described in relation to the spray device, these aspects may also be realized correspondingly in the use of the spray device, the method and a computer program that implements the method. In just the same way, the aspects that are described above in relation to the display method may also be realized correspondingly in the spray device and in the use of the spray device.

### BRIEF DESCRIPTION OF THE DRAWINGS

The present disclosure will be explained further with reference to figures.

In these figures, schematically:

FIG. 1 shows a block diagram of a spray device according to an embodiment;

FIG. 2 shows a possible realization of the spray device according to the embodiment from FIG. 1;

FIG. 3 shows a flow diagram of a method according to a first embodiment, which may be realized with the spray device according to the embodiment from FIGS. 1 and 2; and

FIG. 4 shows a flow diagram of a method according to a second embodiment, which may be realized with the spray device according to the embodiment from FIGS. 1 and 2.

### DETAILED DESCRIPTION OF THE PREFERRED EMBODIMENTS

Below, specific details are set forth, without any restriction thereto, in order to provide complete understanding of the present disclosure. However, it will be clear to those skilled in the art that the present disclosure can be used in other embodiments, which may differ from the details set forth below. For example, below it is mentioned consistently that the components to be sprayed are those of an aircraft. However, the spray device may also be used to apply spraying agent to components of other types.

It will be clear to those skilled in the art that the explanations given below are/may be implemented using hardware circuits, software elements or a combination thereof The software elements may be associated with programmed microprocessors or a general computer, an ASCI (application specific integrated circuit) and/or DSPs (digital signal processors). It will moreover be clear that, even where the details below are described in relation to a method, these details may also be realized in a suitable device unit, a computer processor or a memory connected to a processor, with the memory provided with one or more programs that perform the method when they are carried out by the processor.

The attached figures merely serve the purpose of illustrating embodiments. They are not to scale and are intended merely to reflect the general concept of the disclosure by way of example. For example, features which appear in the figures are in no way considered an essential constituent.

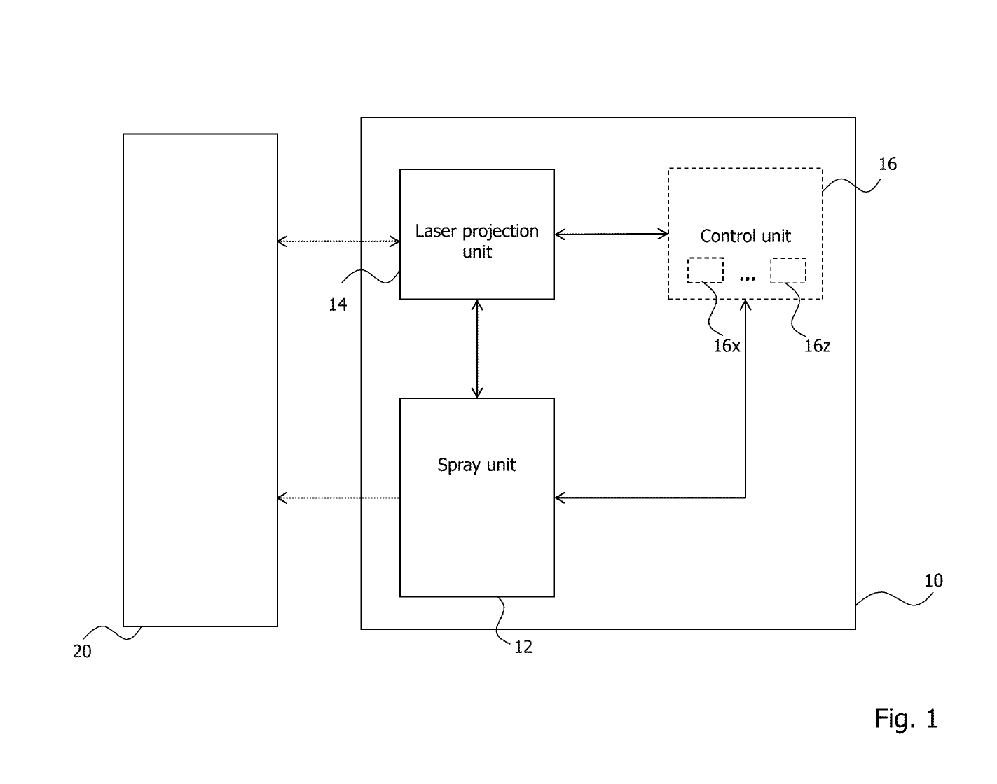

FIG. 1 shows a block diagram of a spray device 10 according to an embodiment. The spray device 10 includes a spray unit 12 and a light projection unit 14. Further, the spray device may include a control unit 16. The control unit 16 may include one or more control sub-units which are illustrated by way of example by the control sub-units 16x to 16z, to illustrate the fact that any conceivable number of control sub-units may be provided. The light projection unit 14 is configured to project light onto a component 20 to be sprayed, as a function of at least one parameter of a spraying procedure that is performable by means of the spray unit 12, in such a way that a resulting projection of the light onto the component 20 to be sprayed displays a region of the component 20 to be sprayed which is sprayed during performance of the spraying procedure, using the at least one parameter.

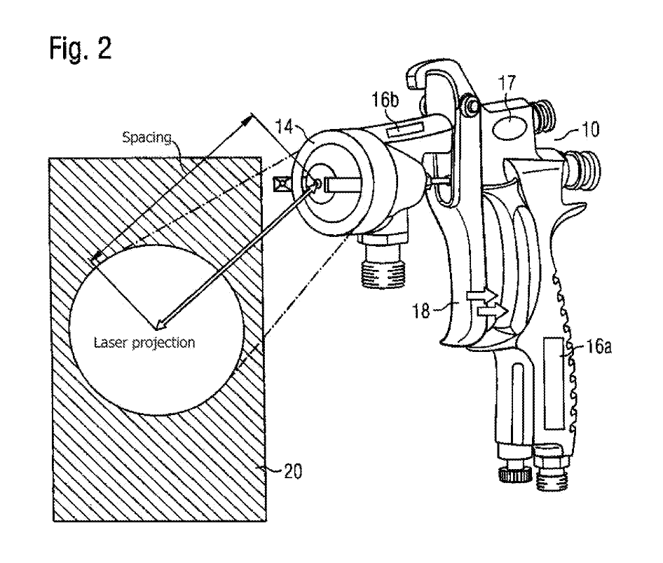

FIG. 2 shows a possible realization of the spray device 10 according to the embodiment from FIG. 1. According to the realization shown in FIG. 2, the spray device 10 is configured—purely by way of example, and without being restricted thereto—as a spray gun. The spray device 10 from FIG. 2 includes a spray unit, which is not provided with a reference numeral in FIG. 2 and which continues to be designated a spray unit 12 below, using the reference numeral from FIG. 1. With the aid of the spray unit 12, a spraying agent may be applied to a component 20 to be sprayed. Further, the spray device 10 from FIG. 2 includes as the light projection unit 14—purely by way of example and without being restricted thereto—a laser projection unit. The laser projection unit is a conceivable realization of the light projection unit 14 and is designated a laser projection unit 14 below. The spray device 10 includes—purely by way of example—two control sub-units, as mentioned in relation to FIG. 1 as part of the control unit 16, namely a parameter control unit 16a and a jet geometry control unit 16b. The parameter control unit 16a has by way of example a memory unit and a user interface. Data exchange is made possible by way of the user interface, as will be described below. The spray device 10 includes by way of example a position sensor 17 as a position determining unit. With the aid of the position sensor 17, the position of the spray device 10 may be determined. The spray device 10 further includes an actuating element 18 which, purely by way of example, is constructed as a grip.

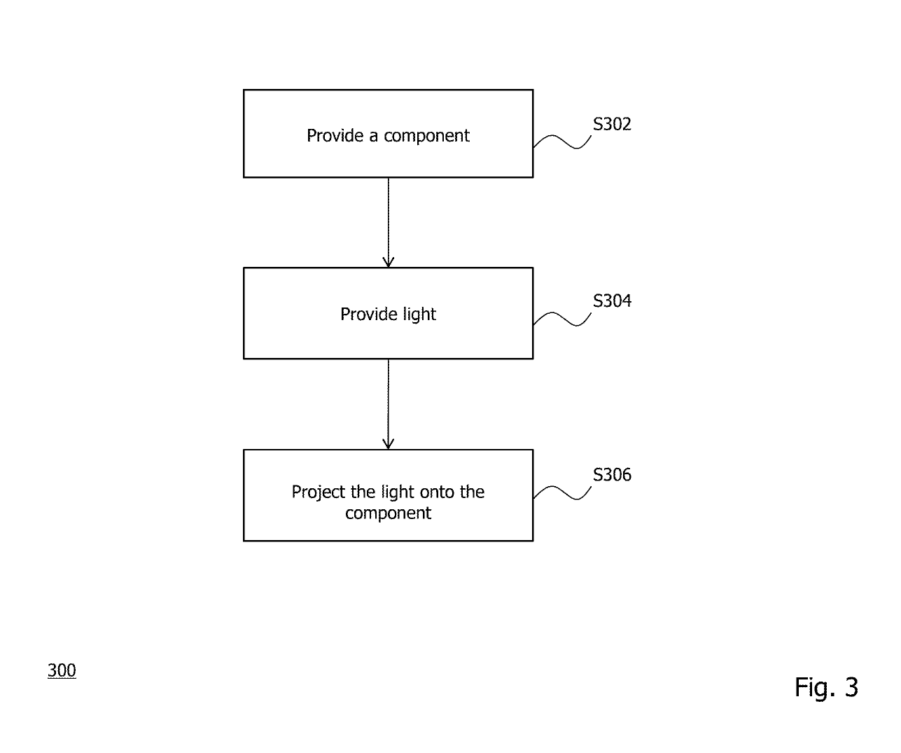

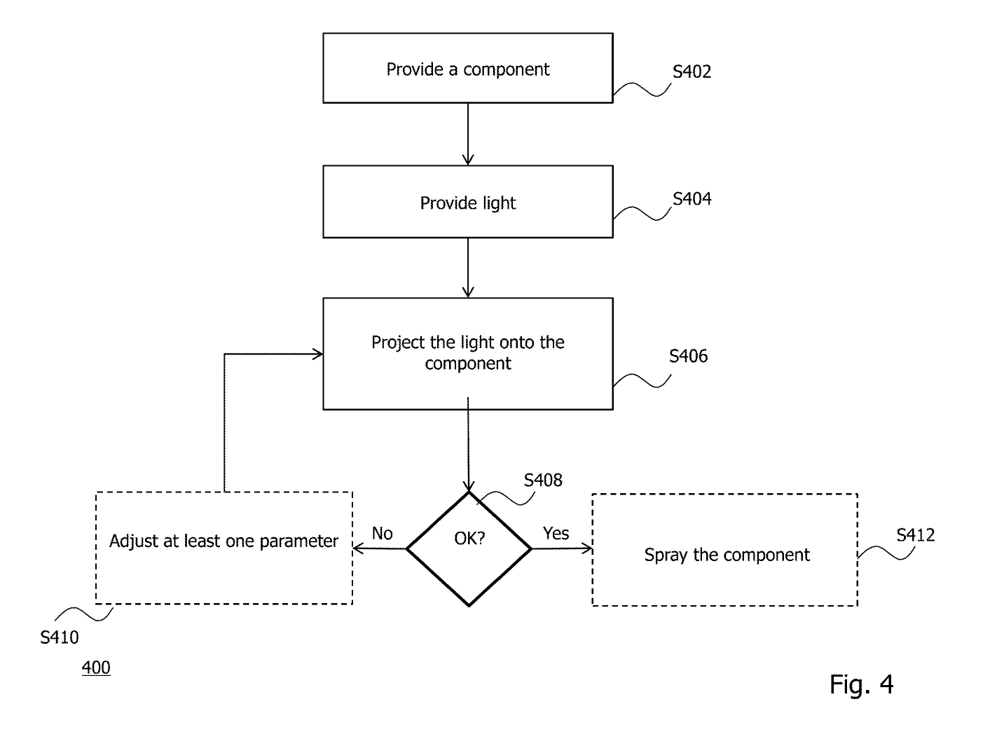

Details of the spray device 10 and possible functions of the spray device 10 from FIGS. 1 and 2 will now be explained with reference to the methods according to the flow diagrams shown in FIGS. 3 and 4.

FIG. 3 shows a flow diagram of a method for displaying a region of a component to be sprayed, according to a first embodiment. The method includes the steps of: providing the component 20 that is to be sprayed, in step S302; providing light, in step S304; and projecting light as a function of at least one parameter of a spraying procedure that is to be performed onto the component 20 to be sprayed, in such a way that a resulting projection of the light onto the component 20 to be sprayed displays a region of the component 20 to be sprayed which is sprayed during performance of the spraying procedure, using the at least one parameter (step S306).

FIG. 4 shows a flow diagram of a method for displaying a region to be sprayed, according to a second embodiment. Here, the steps S402, S404 and S406 correspond to the steps S302, S304 and S306 as described in relation to FIG. 3. For this reason, a repetition at this point of a description of these steps will be dispensed with. Instead, the reader is referred to the description of steps S302 to S306.

In step S408, a determination is made of whether the projection of the light corresponds to a region that is in fact to be provided with spraying agent. The user can carry out this determination themselves. During the determination, a check is made (S408) of whether the region displayed by the projection at least almost corresponds to the region that is in fact to be provided with spraying agent during a spraying procedure that is to be or has been performed. If it is established that the laser projection is unsatisfactory, that is to say for example that it differs from the region to be sprayed by more than a fixed tolerance value, then at least one parameter is adjusted (S410). Purely by way of example, it may be mentioned here that another spraying agent is selected. Using this changed parameter—and maintaining the remaining parameters—a new laser projection is generated in step S406. A new check is now made (S408) of whether the laser projection corresponds to the region to be sprayed with satisfactory precision. If this continues not to be the case, then at least one parameter may again be changed (step S410). Purely by way of example, it may be mentioned here that another spacing is set and another spacing is established. Using this changed parameter—and maintaining the remaining parameters—a new laser projection is generated in step S406. A new check is now made (S408) of whether the laser projection corresponds to the region to be sprayed with satisfactory precision. If this continues not to be the case, then at least one parameter may again be changed (step S410). Purely by way of example, it may be mentioned here that another spraying pressure is established. A new check is now made (S408) of whether the laser projection corresponds to the region to be sprayed with satisfactory precision. If the laser projection corresponds sufficiently precisely to the region to be sprayed, the spraying procedure may be performed or continued using the parameters that were last used to generate the laser projection (step S412). To this extent, generation of the laser projection may be regarded as a type of simulation of the actual spraying procedure.

Since the region of the component that is expected to be sprayed is displayed to the user before any spraying procedure, the user can decide to perform the spraying procedure or to make adjustments first. This makes it possible to perform the spraying procedure as exactly as possible. Since, further, the region of the component that is expected to be sprayed is displayed to the user during a spraying procedure, the user can monitor the result of the spraying procedure directly. This also increases the precision of the spraying procedure.

As a consequence, there is no unnecessary waste of spraying agent and no unnecessary increase in weight of the component. By planning the spraying procedure already at the start, that is to say before the actual spraying procedure, a more precise spraying procedure is achieved. Since the spraying procedure is performed in a more targeted manner, the load on the user by the spraying agent is minimized. This improves aspects that have relevance to health and safety.

The specific realization from FIG. 2, given by way of example, provides a simple mechanism to perform the steps that are described in relation to steps S408 to S412 quickly and simply. For this purpose, the actuating element 18 that by way of example takes the form of a grip may be moved from a starting position into two further positions. This is illustrated by the arrows in FIG. 2. By moving the actuating element 18 in the direction of the handle of the spray device 10, the actuating element 18 is first transferable from the starting position into a first position. In the first position, the parameter control unit 16a instructs the laser projection unit 14 to project laser light (a beam of laser light) onto the component 20. Here, either pre-set parameters or parameters that are input by way of the user interface arranged on the parameter control unit 16a are used. Taking these parameters into account, the laser light is projected by the laser projection unit 14. If the laser projection meets expectations, in that it corresponds to the region of the component 20 to be sprayed sufficiently precisely, the actuating element 18 may be moved further in the direction of the handle, into a second position. In this second position, the spraying procedure is ultimately performed using exactly the parameters that were fixed in the first position. If by contrast the laser projection does not meet expectations, the actuating element 18 may be moved back into the starting position. At this stage an adjustment may for example be made to one or more parameters. The adjustment may be carried out at the parameter control unit 16a, with the aid of the user interface. Purely by way of example, it is assumed that the user selects another spraying agent. The other parameters remain for example unchanged. Thereafter, the actuating element 18 is moved into the first position and the laser projection that is subsequently generated is checked. If it meets the requirements, the actuating element 18 may be moved into the second position in order to start the spraying procedure, using the parameters that were last used in the first position of the actuating element to check the spraying procedure.

The specific realization from FIG. 2, given by way of example, has a type of safety mechanism which prevents the spraying procedure from being carried out at an impermissible spacing. The computing steps that are required for the safety mechanism may for example be implemented in the parameter control unit 16a. For this purpose, the spraying device from FIG. 2 has a spacing determination unit. The spacing determination unit may be integrated into the laser projection unit 14, and for the sake of simplicity this will be assumed below. The laser beam which is generated by the laser projection unit 14 and projected onto the component 20 may be used for determining the spacing between the region of the component 20 that is to be sprayed and the spray device 10. For calculating the spacing, various methods are conceivable. For example, the spacing may be calculated by way of the propagation time of the laser beam, that is to say by way of the time period between emission of the laser beam from the laser projection unit 14 and reception of the laser beam that is at least partially reflected at the component 20, for example at the laser projection unit 14. If the determined spacing differs by a predetermined and/or settable value from a permissible spacing or spacing range, the spraying function may be blocked. The difference may include falling short of a value as well as exceeding a value. By recognizing the falling short of a permissible minimum spacing and accordingly blocking the spraying procedure, it is possible to prevent spraying agent from being applied even though there is no possibility of targeted application. By recognizing the exceeding of a permissible maximum spacing and accordingly blocking the spraying procedure, it is possible to avoid an attempt to apply spraying agent even though the spray device is too far away from the component to apply sufficient spraying agent, or any at all, to the component 20.

As mentioned above, the specific realization from FIG. 2, given by way of example, has the jet geometry control unit 16b. The jet geometry control unit 16b is for example connected to the parameter control unit 16a and the associated user interface. Parameters that are input with the aid of the user interface may thus reach the jet geometry control unit 16b and be used there. The jet geometry control unit 16b may change the geometry of the jet of spraying agent, on the basis of the parameters that are input. The term “geometry of the jet” may in this case be understood to mean for example the cross section of the spraying agent perpendicular to the direction of propagation. To adjust the geometry of the jet of spraying agent, it is possible for example to provide a miniaturized motor in the jet geometry control unit 16b.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A spray device comprising:
a spray unit; and
a light projection unit configured to project light onto a component to be sprayed as a function of at least one parameter of a spraying procedure performable via the spray unit, in such a way that a resulting projection of light onto the component to be sprayed displays a region of the component to be sprayed which is sprayed during performance of the spraying procedure, using the at least one parameter.

2. A spray device according to claim 1, wherein the light projection unit is configured to adjust the light projection as a function of the at least one parameter.

3. A spray device according to claim 1, wherein the at least one parameter includes at least one of:
information relating to a spraying agent that may be used in the spraying procedure;
information relating to a possible spacing between the spray device and the component to be sprayed during the spraying procedure;
information relating to a spraying pressure that may be used in the spraying procedure; and
information relating to a jet geometry of a usable spraying agent that may be used in the spraying procedure.

4. A spray device according to claim 1, further including a memory unit in which there is stored information relating to an influence of the at least one parameter on the light projection.

5. A spray device according to claim 4, wherein the information relating to the influence of the at least one parameter on the light projection may be updatable on the basis of performed spraying procedures.

6. A spray device according to claim 1, further including a user interface by way of which the at least one parameter may be input.

7. A spray device according to claim 1, further including a spacing measurement unit configured to determine the spacing between the spray device and the region of the component that is to be sprayed.

8. A spray device according to claim 1, further including a position determining unit configured to determine the position of the spray device relative to the component to be sprayed.

9. A spray device according to claim 1, further including a blocking control unit configured to block the spraying procedure if the spacing between the spray device and the region of the component to be sprayed lies outside a range of usable spacings.

10. A spray device according to claim 1, further including a blocking control unit configured to block the spraying procedure if the position of the spray device relative to the component to be sprayed lies outside a range of usable positions.

11. A spray device according to claim 1, further including an actuating element and an actuation control unit, wherein the actuating element is movable from a starting position into a first and a second position, and the actuation control unit is configured, in the first position of the actuating element, to instruct the light projection unit to project the light onto the component to be sprayed as a function of the at least one parameter and, in the second position of the actuating element, to instruct the spray unit to perform the spraying procedure using the at least one parameter.

12. A spray device according to claim 1, further including a jet geometry control unit configured to set a geometry of a jet of a used spraying agent emitted by the spray unit.

13. A spray device according to claim 1, wherein the light projection unit includes a laser source configured to generate laser light, as the light to be projected.

14. A method of using a spray device according to claim 1 to spray a component of an aircraft.

15. A method for displaying a region of a component to be sprayed, comprising the steps:
providing the component that is to be sprayed;
providing a source of light; and
projecting the light as a function of at least one parameter of a spraying procedure that is to be performed onto a component to be sprayed in such a way that a resulting projection of the light onto the component to be sprayed displays a region of the component to be sprayed which is sprayed during performance of the spraying procedure, using the at least one parameter.
